(19) United States
(12) Patent Application Publication
(10) Pub. No.: US 2012/0240748 A1
(43) Pub. Date: Sep. 27, 2012

(54) KEYBOARD INSTRUMENT

(76) Inventor: Norie Endow, Aichi (JP)

(21) Appl. No.: 13/514,927

(22) PCT Filed: Jan. 29, 2010
(86) PCT No.: PCT/JP2010/051193

§ 371 Date: Jun. 8, 2012

(30) Foreign Application Priority Data
Dec. 10, 2009 (JP) 2009-280463

(51) Int. Cl. G10C 3/12

(52) U.S. Cl. 84/433

(57) ABSTRACT

A keyboard instrument is provided in order to further improve expressiveness as a keyboard instrument while ease in performing is ensured. In the keyboard, a plurality of keys is lined up in order, and each supported so as to be pivotable about a supporting point. The keys include first keys, second keys, and third keys. The first keys, the second keys, and the third keys constitute key portions, in which the first keys, the second keys, and the third keys are respectively lined up according to types of the keys in a lateral direction and disposed in order of the first keys, the second keys, and the third keys from a front side. The key portions are disposed on a plurality of steps in an up-and-down direction. Each of the key portions is constituted such that between two first key pieces, having a pitch different by a whole tone, cutouts are formed in mutually facing portions of the respective first keys, and two second key pieces are disposed therein; between two second key pieces adjacently disposed, cutouts are formed in mutually facing portions of the respective second keys, and one piece of the third keys is disposed therein; between two first key pieces, having a pitch different by a half tone, cutouts are formed in mutually facing portions of the respective first keys, and one piece of the second keys is disposed therein. Therefore, the pitch between the first keys and the second keys adjacently disposed, and the pitch between the second keys and the third keys adjacently disposed respectively become quarter tones.

### TECHNICAL FIELD

The present invention is related to a keyboard instrument wherein sound is produced by striking keys or bars lined up in a lateral direction with respect to a player.

### BACKGROUND ART

A keyboard instrument, such as an acoustic piano, includes keys, hammers, and strings. The keys are lined up in a lateral direction, and supported by balance key pins in approximately central portions of the keys so as to be pivotable about the pins in an up-and-down direction. The hammers are provided correspondingly to the respective keys, and moved in conjunction with the keys. The strings are provided corresponding to the respective keys. The strings are approximately horizontally pulled in a taut manner to a predetermined tension by securing the end portions thereof with tuning pins and frame pins. The keyboard instrument is constructed such that when one of the keys is pressed by a player, the hammer that is moved in conjunction with the pressed key strikes a corresponding string, and sound is produced (see, for example, Patent Document 1).

In such a keyboard instrument, in order to improve expressiveness as a musical instrument, intervals of sound (pitch) that can be produced by the keyboard instrument are preferably made smaller, and the range of the sound that can be produced by the keyboard instrument is preferably widened. This can be achieved by increasing the number of keys and strings, because of the structural characteristics of the keyboard instrument wherein tones for respective keys and strings need to be set in advance. All of the keys need to be disposed within a range sufficiently reachable by the hands of a player who is seated in front of the keyboard instrument and plays the keyboard instrument. However, if the number of keys is excessively increased, fingering during playing can be more easily disturbed. Moreover, making the size of the respective keys small in order to increase the number of keys can disturb fingering during playing.

From the aspect of achieving these contradictory requirements at a high level, in the current standard keyboard instruments, the size of the keys is determined in consideration of the lengths and widths of fingers of players. A standard keyboard instrument is provided with a key board having 88 key pieces, constituted with 52 white key pieces and 36 black key pieces, lined up in the lateral direction. A standard keyboard instrument is structured so as to be able to produce sound in a seven octaves plus minor third range on a half-tone basis.

In this case, the above-described white keys and the black keys are lined up according to the types of the keys in the lateral direction. Specifically, the white keys are disposed in a front row, and the black keys are disposed in a rear row. Between two white key pieces having a pitch different by a whole tone, cutouts are formed in mutually facing portions of the respective keys, and a black key is disposed therein. The pitch between adjacently disposed white key and black key is a half tone. Between two white key pieces having a pitch different by a half tone, the above-described cutouts are not formed, and no black key is disposed therebetween. A step is created between the white keys and the black keys. The height of the respective black keys is higher than the height of the respective white keys.

### Prior Art Document

### Patent Document

Patent Document 1: Unexamined Japanese Patent Publication No. 07-219522 (Page 5, FIG. 1)

### SUMMARY OF THE INVENTION

### Problems to be Solved by the Invention

To further improve the expressive capacity as a musical instrument in the above-described keyboard instrument, the aforementioned contradictory requirements are preferably met in quality manner.

Such problems may be similarly caused in other instruments having keyboards, for example, in keyboard instruments such as pipe organs, cembalos, pianos, and accordions, and in chromatic percussion instruments such as marimbas, xylophones, and vibraphones. The pianos may be acoustic pianos, such as grand pianos and upright pianos, or electronic pianos (electronic keyboard instruments).

The present invention preferably provides a keyboard instrument with a technique in order to further improve expressiveness as a musical instrument, while ease in performing is ensured.

### Means for Solving the Problem

In a keyboard instrument according to a first aspect of the present application, a plurality of keys is lined up in order, and each supported so as to be pivotable about a supporting point. When the keys are pressed, rear end portions of the keys rotate corresponding hammers, and leading end portions of the rotating hammers strike strings so as to produce sound. The keyboard instrument has strings pulled in a taut manner to a predetermined tension by securing the end portions thereof with tuning pins and frame pins. The keys include first keys, second keys, and third keys. The first keys, the second keys, and the third keys constitute key portions, in which the first keys, the second keys, and the third keys are respectively lined up according to types of the keys in a lateral direction and disposed in order of the first keys, the second keys, and the third keys from a front side. The key portions are disposed on a plurality of steps in an up-and-down direction. Each of the key portions is constituted such that between two first key pieces, having a pitch different by a whole tone, cutouts are formed in mutually facing portions of the respective first keys, and two second key pieces are disposed therein; between two second key pieces adjacently disposed, cutouts are formed in mutually facing portions of the respective second keys, and one piece of the third keys is disposed therein; and between two first key pieces, having a pitch different by a half tone, cutouts are formed in mutually facing portions of the respective first keys, and one piece of the second keys is disposed therein. The hammer and the strings are provided correspondingly to the respective keys. The strings are respectively pulled in a taut manner such that the pitch between the first keys and the second keys adjacently disposed, and the pitch between the second keys and the third keys adjacently disposed respectively become quarter tones.

In the keyboard instrument according to the present invention which is constructed as above, each of the strings is pulled and disposed such that the pitch between the adjacently disposed first key and the second key, and the pitch between the adjacently disposed second key and the third key respectively become quarter tones. This enables the keyboard instrument to produce sound on a quarter-tone basis. Moreover, since the key portions are disposed on a plurality of steps in the up-and-down direction, even though the number of keys is increased so that the keyboard instrument can produce sound on a quarter-tone basis and the range of the sound that the keyboard instrument can produce is widened, all of the keys are disposed within a range sufficiently reachable by the hands of a player who is seated in front of the keyboard instrument and performs. Additionally, even though the number of keys is increased, the size of the respective keys does not have to be made smaller. Therefore, fingering during performance is not easily disturbed.

As a result, while ease in performing is ensured, expressiveness as a musical instrument may be further improved.

In a keyboard instrument according to a second aspect of the present application, a plurality of keys is lined up in order, and each supported so as to be pivotable around a supporting point. When the keys are pressed, rear end portions of the keys, which are being rotated, are detected so as to produce sound. The keys include first keys, second keys, and third keys. The first keys, the second keys, and the third keys constitute key portions, in which the first keys, the second keys, and the third keys are respectively lined up according to types of the keys in a lateral direction, and disposed in order of the first keys, the second keys, and the third keys from a front side. The key portions are disposed on a plurality of steps in an up-and-down direction. Each of the key portions is constituted such that between two first key pieces, having a pitch different by a whole tone, cutouts are formed in mutually facing portions of the respective first keys, and two second key pieces are disposed therein; between two second key pieces adjacently disposed, cutouts are formed in mutually facing portions of the respective second keys and one piece of the third keys is disposed therein; and between two first key pieces, having a pitch different by a half tone, cutouts are formed in mutually facing portions of the respective first keys, and one piece of the second keys is disposed therein. The pitch between the first keys and the second keys adjacently disposed, and the pitch between the second keys and the third keys adjacently disposed are set so as to respectively become quarter tones.

In the keyboard instrument according to the present invention which is constructed as above, the pitch between adjacently disposed first key and the second key and the pitch between adjacently disposed second key and the third key are respectively set to be quarter tones. Therefore, the keyboard instrument can produce sound on a quarter-tone basis. Moreover, the key portions are disposed on a plurality of steps in the up-and-down direction. Therefore, even though the number of keys is increased so that the keyboard instrument can produce sound on a quarter-tone basis, and the range of the sound that the keyboard instrument can produce is widened, all of the keys are disposed within a range sufficiently reachable by the hands of a player who is seated in front of the keyboard instrument and performs. Additionally, even though the number of keys is increased, the size of the respective keys does not have to be made smaller. Therefore, fingering during performance is not easily disturbed.

As a result, while ease in performing is ensured, expressiveness as a musical instrument may be further improved.

In a keyboard instrument according to a third aspect of the present application, sound is produced by a plurality of bars, lined up in order, being struck, and volume of the sound is increased by pipes, suspended under the bars, resonating with the sound and being vibrated. The keyboard instrument has bars provided with a plurality of primary-tone bars, disposed in a front-row side, and a plurality of accidental-tone bars, disposed in a rear-row side. The bars are disposed on a plurality of steps in a front-to-rear direction. The primary-tone bars are constituted with first bars lined up in a lateral direction. The accidental-tone bars are constituted with second bars, third bars, and fourth bars respectively lined up in the lateral direction. Between two first bar pieces, having a pitch different by a whole tone, the second bar is disposed. Between the first bar and the second bar, having a pitch different by a half tone, the third bar is disposed. Between two first bar pieces having a pitch different by a half tone, the fourth bar is disposed. The pitch between the first bars and the second bars adjacently disposed, the pitch between the second bars and the third bars adjacently disposed, the pitch between the first bars and the third bars adjacently disposed, and the pitch between the first bars and the fourth bars adjacently disposed respectively become quarter tones.

In the keyboard instrument according to the present invention which is constructed as above, since the pitches between adjacently disposed bars are respectively set to be quarter tones, the keyboard instrument can produce sound on a quarter-tone basis. Moreover, since bars are disposed on a plurality of steps in the up-and-down direction, even though the number of bars is increased so that the keyboard instrument can produce sound on a quarter-tone basis and the range of the sound that the keyboard instrument can produce is widened, all of the bars are disposed within a range sufficiently reachable by the hands of a player who is seated in front of the keyboard instrument and performs. Additionally, even though the number of bars is increased, the size of the respective bars does not have to be made smaller. Therefore, fingering is not easily disturbed during performance.

As a result, while ease in performing is ensured, expressiveness as a musical instrument may be further improved.

### BRIEF DESCRIPTION OF THE DRAWINGS

FIG. 1 is an external view showing a grand piano 1.

FIG. 2 is a sectional view showing a front portion of the grand piano 1.

FIG. 3 is a detail view showing a key portion 30, keys 115, and key portion 230.

FIG. 4 is an external view showing an electronic keyboard instrument 101.

FIG. 5 is a block diagram showing a circuit structure of the electronic keyboard instrument 101.

FIG. 6 is a sectional view showing the electronic keyboard instrument 101.

FIG. 7 is a detail view showing a key portion according to another embodiment;

FIG. 8 is an external view showing an upright piano 201.

FIG. 9 is a sectional view showing a front portion of the upright piano 201.

FIG. 10 is an external view showing a marimba 301. FIG. 11 is a detail view showing a bar 305 of the marimba 301. FIG. 12 is a detail view showing a bar according to another embodiment.

### EXPLANATION OF NUMERALS

1 . . . grand piano, 2 . . . string, 3,5 . . . action device, 10 . . . piano main body, 30 . . . key portion, 32 . . . key, 32a . . . first key, 32b . . . second key, 32c . . . third key, 33 . . . key, 33a . . . first key, 33b . . . second key, 33c . . . third key, 34 . . . key bed, 36 . . . middle key bed, 40 . . . transmission portion, 42 . . . hammer, 44 . . . action, 46 . . . hammer shank rail, 101 . . . electronic keyboard instrument, 110a . . . shelf board, 110b . . . middle shelf board, 111a . . . keyboard chassis, 111b . . . keyboard chassis, 112 . . . action chassis, 113 . . . balance pin, 114a . . . rear end portion of key, 115 . . . key, 115a . . . first key, 115b . . . second key, 115c . . . third key, 116 . . . hammer supporting portion, 117 . . . switch attachment portion, 118 . . . hammer stopper, 119 . . . key, 119a . . . first key, 119b . . . second key, 119c . . . third key, 120a . . . keyboard device, 120b . . . keyboard device, 122 . . . key placement portion, 155 . . . hammer mechanism, 160 . . . key switch, 175 . . . sound generation control circuit, 176 . . . key scan circuit, 181 . . . waveform memory, 182 . . . sound source LSI, 185 . . . sound generation portion, 186 . . . amplifier, 187 . . . speaker, 201 . . . upright piano, 202 . . . string, 203, 205 . . . action device, 210 . . . piano main body, 214 . . . frame, 230 . . . key portion, 232 . . . key, 232a . . . first key, 232b . . . second key, 232c . . . third key, 233 . . . key, 233a . . . first key, 233b . . . second key, 233c . . . third key, 234 . . . key bed, 236 . . . middle key bed, 240 . . . transmission portion, 242 . . . hammer, 244 . . . action, 301 . . . marimba, 305 . . . bar, 3051 . . . primary-tone bar, 3052 . . . accidental-tone bar, 3053 . . . accidental-tone bar, 306a . . . first bar, 306b . . . second bar, 306c . . . third bar, 306d . . . fourth bar, 307 . . . pipe, 3071 . . . primary-tone pipe, 3072 . . . accidental-tone pipe, 3073 . . . accidental-tone pipe, 309 . . . instrument stand.

### MODE FOR CARRYING OUT THE INVENTION

Embodiments of the present invention are described below with reference to the drawings.

### First Embodiment

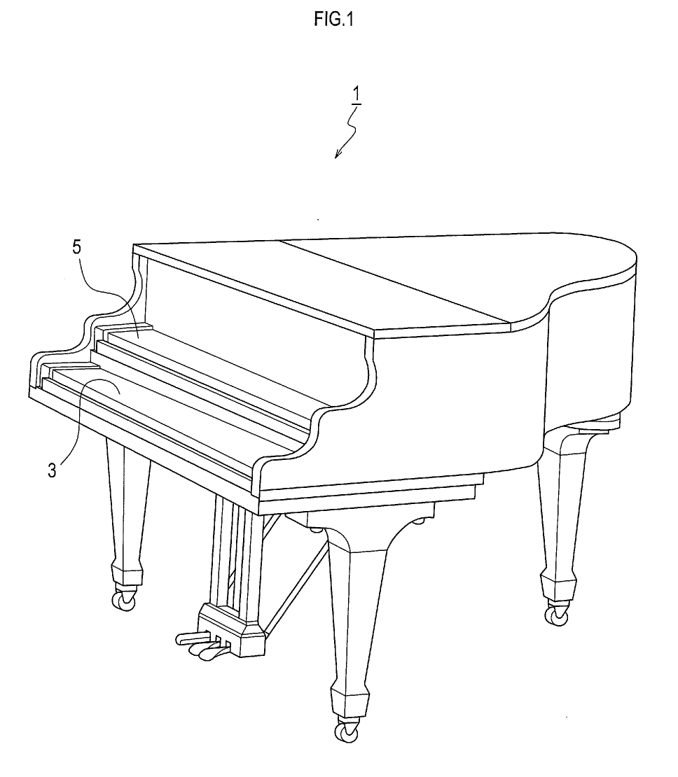

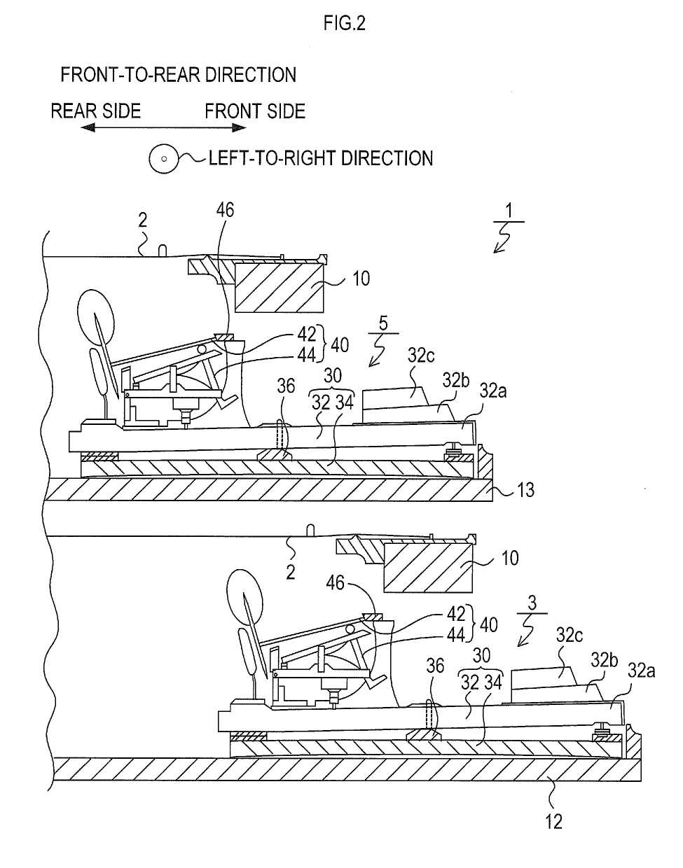

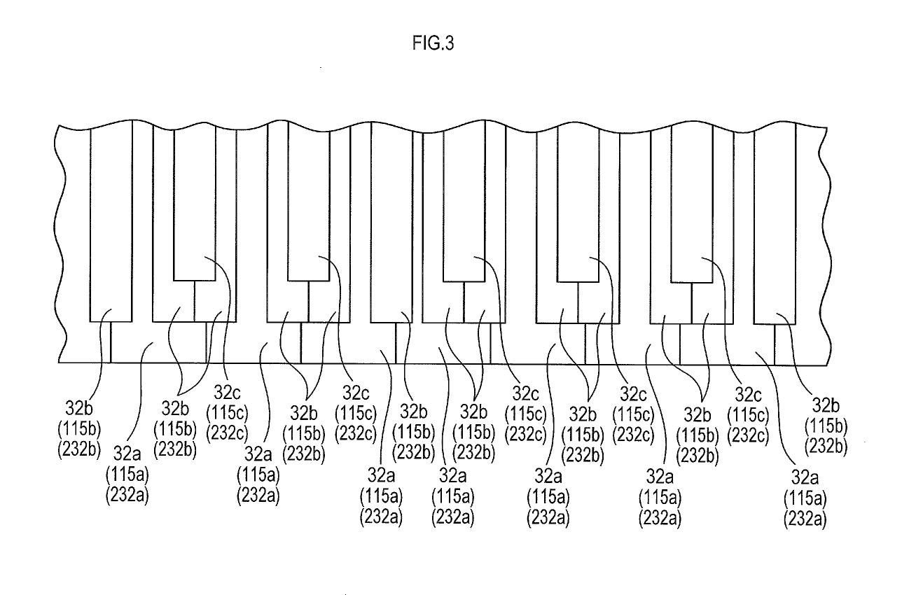

FIG. 1 is an external view showing a grand piano 1. FIG. 2 is a sectional view showing a front portion of the grand piano 1. FIG. 3 is a detail view showing a key portion 30 and keys 115. It is to be noted that, in FIG. 1, the key portions 30 of action devices 3, 5, and a keyboard cover panel, provided so as to cover the action devices 3, 5, are not shown.

[1. Description of Structure of Grand Piano 1]

The grand piano 1 according to the present embodiment is provided with, as shown in FIG. 1, two action devices 3, 5 so as to strike strings by depression of keys.

The action device 3 is disposed in the front portion of the grand piano 1, whereas the action device 5 is disposed diagonally behind and above the action device 3.

The following describes a structure of the action device 3.

As shown in FIG. 2, the action device 3 is disposed on a shelf board 12 of a piano main body 10. The action device 3 includes the key portion 30 and a transmission portion 40.

The key portion 30 is constituted with keys 32 and a key bed 34, and is disposed on the shelf board 12. The key portion 30 is provided with 95 key pieces 32 for four octaves. The respective keys 32 are disposed in parallel on the key bed 34. The key bed 34 is a long plate member extending in the arrangement direction of the keys 32 (lateral direction). In the middle of a width direction of the key bed 34, a middle key bed 36 extending in the arrangement direction of the keys 32 is disposed. The keys 32 are disposed on the key bed 34 so as to pivot about the middle key bed 36 as a supporting point.

The keys 32 include first keys 32a, second keys 32b, and third keys 32c. The key portion 30 is provided with 28 first key pieces 32a, 47 second key pieces 32b, and 20 third key pieces 32c. The first keys 32a, the second keys 32b, and the third keys 32c are respectively lined up linearly in a lateral direction, and disposed in the order of the first keys 32a, the second keys 32b, and then the third keys 32c from the front side. In FIG. 3, the keys 32 for one octave are shown.

It is to be noted that the first keys 32a are white, the second keys 32b are blue, and the third keys 32c are black.

Moreover, a step is created between the first keys 32a and the second keys 32b. A step is also created between the second keys 32b and the third keys 32c. Heights (positions) of the respective keys 32 are: the first keys 32a are the lowest; the second keys 32b are higher than the first keys 32a; and the third keys 32c are higher than the second keys 32b, in other words, the highest of all.

It is to be noted that the first keys 32a correspond to white keys of a conventional grand piano, and that the third keys 32c correspond to black keys of a conventional grand piano.

As shown in FIG. 3, between two first key pieces 32a, having a pitch different by a whole tone, cutouts are respectively formed in mutually facing portions of the first keys 32a, and two second key pieces 32b are disposed in the cutouts. Between two adjacently disposed second key pieces 32b, cutouts are respectively formed in mutually facing portions of the second keys 32b, and one piece of the third key 32c is disposed in the cutouts. Between two first key pieces 32a, having a pitch different by a half tone, cutouts are respectively formed in mutually facing portions of the first keys 32a, and one piece of the second keys 32b is disposed in the cutouts.

Referring again to FIG. 2, the transmission portion 40 is constituted with hammers 42 and actions 44. The hammers 42 and the actions 44 are provided correspondingly to the keys 32. Above approximately center portions in a longitudinal direction of the keys 32, a hammer shank rail 46 is disposed along the arrangement direction of the keys 32. The hammers 42 are pivotably attached to the hammer shank rail 46. On the other hand, each of the actions 44 is disposed in a position between the hammer 42 and the key 32, and in a position wherein the action 44 is lifted up, when the key 32 is pressed, so as to raise the hammer 42. It is to be noted that the actions 44 have a structure generally used for actions provided in the grand piano 1, and therefore detailed description thereof is not given here.

Strings 2 are provided correspondingly to the respective keys 32. The strings 2 for respective pitches are secured at the end portions thereof with tuning pins (not shown) and frame pins (not shown) with respect to a piano main body 10, disposed above the key portions 30, and pulled in an approximately horizontal manner to a predetermined tension. In the grand piano 1 according to the present embodiment, each of the strings 2 is disposed in the pulled manner such that the pitch between adjacently disposed first key 32a and second key 32b, and the pitch between adjacently disposed second key 32b and third key 32c respectively become quarter tones.

In the action device 3, the rear side of the keys 32 is usually inclined because of the weight of the transmission portion 40. When the front side of the key 32 is pressed, the key 32 is pivoted about the middle key bed 36 as a supporting point, and pushes up the hammer 42 via the action 44 so as to strike the string 2. When the operation on the key 32 is stopped, the key 32 is returned to an original position due to the weight of the hammer 42 and the action 44.

The following describes a structure of the action device 5. The action device 5 is disposed, as described above, diagonally behind and above the action device 3. More specifically, the action device 5 is disposed on a middle shelf board 13 of the piano main body 10 disposed above the action device 3. The action device 5 is constituted with the key portion 30 and the transmission portion 40. Since the key portion 30 and the transmission 40 of the action device 5 are constructed similarly to the key portion 30 and the transmission portion 40 of the action device 3, detailed explanation thereof is not repeated here.

The highest tone produced in the key portion 30 of the action device 3 and the lowest tone produced in the key portion 30 of the action device 5 are set so as to be two consecutive tones having a quarter-tone difference therebetween.

Since other structure of the grand piano 1 is based on the conventionally known technique, detailed explanation thereof is not given here.

[2. Effect of First Embodiment]

As described above, in the grand piano 1 according to the present embodiment, the key portion 30 of the action device 3 and the key portion 30 of the action device 5 are respectively provided with 95 key pieces 32 for four octaves. The keys 32 include the first keys 32a, second keys 32b and the third keys 32c. The key portions 30 are respectively provided with 28 first key pieces 32a, 47 second key pieces 32b, and 20 third key pieces 32c. The first keys 32a, the second keys 32b, and the third keys 32c are respectively lined up in the linear manner in the lateral direction, and arranged in the order of the first keys 32a, the second keys 32b, and the third keys 32c from the front side. A step is created between the first keys 32a and the second keys 32b. The step is also created between the second keys 32b and the third keys 32c. The heights (positions) of the respective keys 32 are: the first keys 32a are the lowest; the second keys 32b are higher than the first keys 32a; and the third keys 32c are higher than the second keys 32b, in other words, the highest of all. Furthermore, each of the strings 2 is pulled and disposed such that the pitch between adjacently disposed first key 32a and second key 32b, and the pitch between adjacently disposed second key 32b and third key 32c respectively become quarter tones. This enables the grand piano 1 to produce sound on a quarter-tone basis. Moreover, since the action devices 3, 5 are disposed on a plurality of steps (on two steps in the present embodiment) in the up-and-down direction, even though the number of keys 32 is increased so that the grand piano 1 can produce sound on a quarter-tone basis and the range of the sound that the grand piano 1 can produce is widened, all of the keys 32 are disposed within a range sufficiently reachable by the hands of a player who is seated in front of the grand piano 1 and performs. Additionally, even though the number of keys 32 is increased, the size of the respective keys 32 does not have to be made smaller. Therefore, fingering during performance is not easily disturbed.

As a result, while ease in performing is ensured, expressiveness as a musical instrument can be further improved.

[3. Another Embodiment]

The above has described an embodiment according to the present invention. However, the present invention is not limited to the above-described embodiment, but may be carried out in various ways as explained below.

(1) As shown in FIG. 7, 28 first key pieces 33a, 47 second key pieces 33b, and 20 third key pieces 33c may be lined up in a fan-shape manner. Moreover, the disposition may be in the order of the first keys 33a, the second keys 33b, and the third keys 33c from the front side. In this case, a step may be created between the first keys 33a and the second keys 33b, and also between the second keys 33b and the third keys 33c. The heights (positions) of the respective keys 33 may be: the first keys 33a are the lowest of all; the second keys 33b are higher than the first keys 33a; and the third keys 33c are higher than the second keys 33b, in other words, the highest of all. Between the two first key pieces 33a having a pitch different by a whole tone, cutouts are respectively formed in mutually facing portions of the first keys 33a, and two second key pieces 33b may be disposed in the cutouts. Between two adjacently disposed second key pieces 33b, cutouts are respectively formed in mutually facing portions of the second keys 33b, and one piece of the third key 33c may be disposed in the cutouts. Between two first key pieces 33a, having a pitch different by a half tone, cutouts are respectively formed in mutually facing portions of the first keys 33a, and one piece of the second key 33b may be disposed in the cutouts.

### Second Embodiment

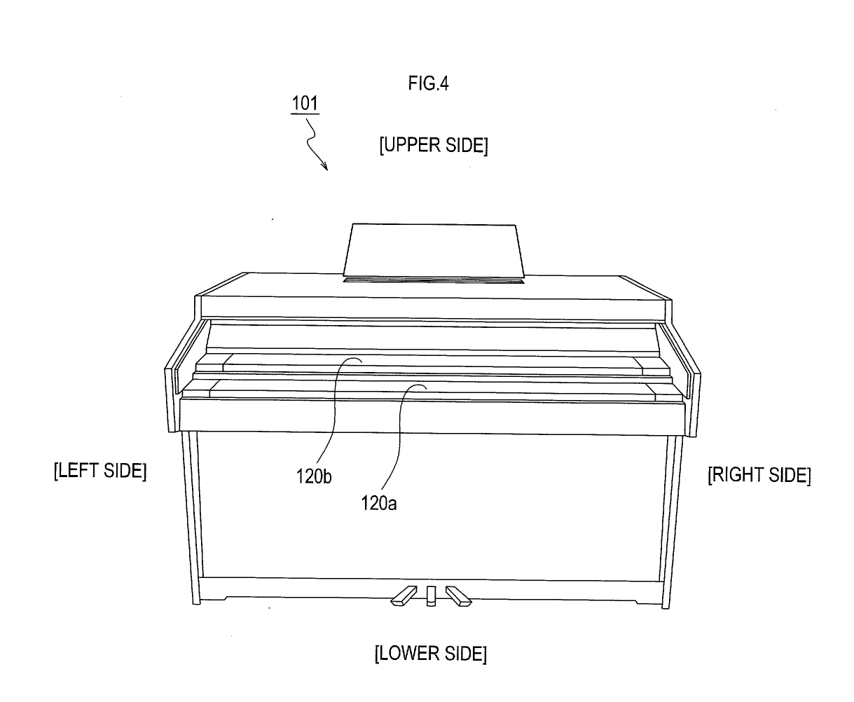

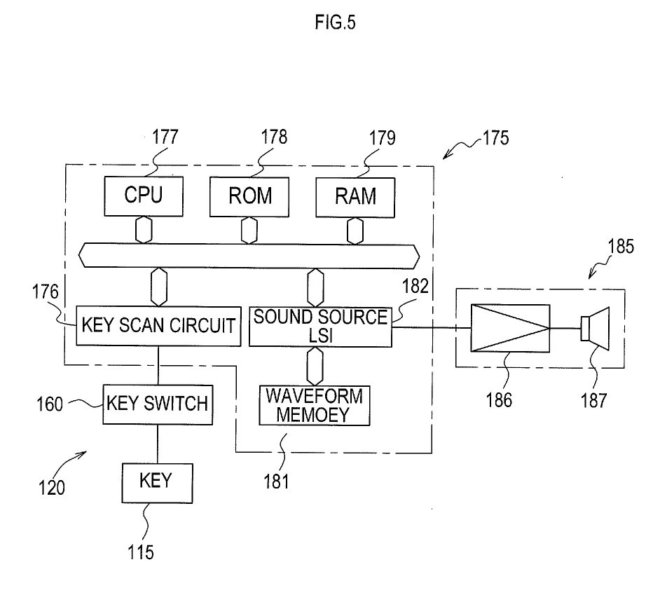

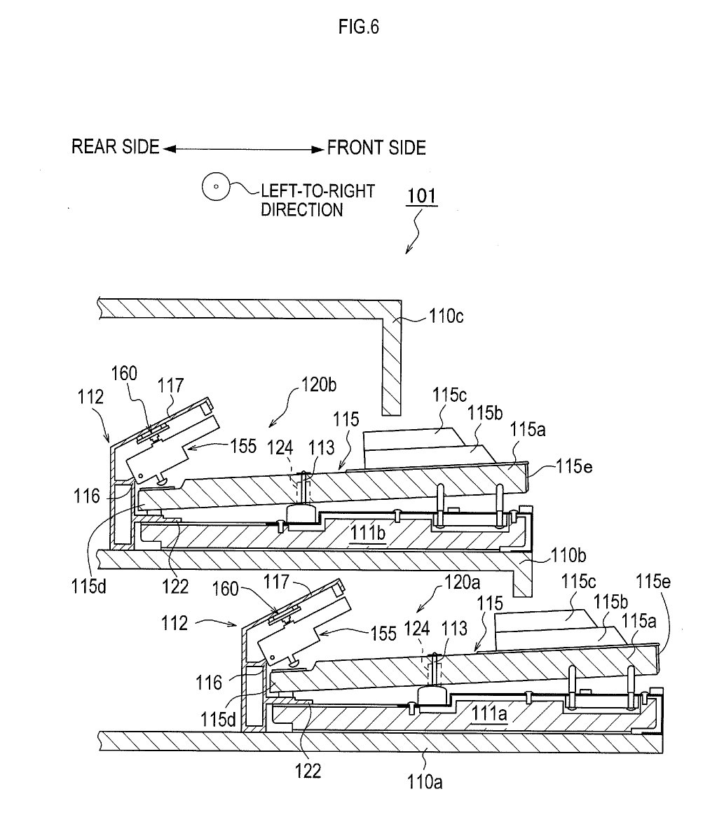

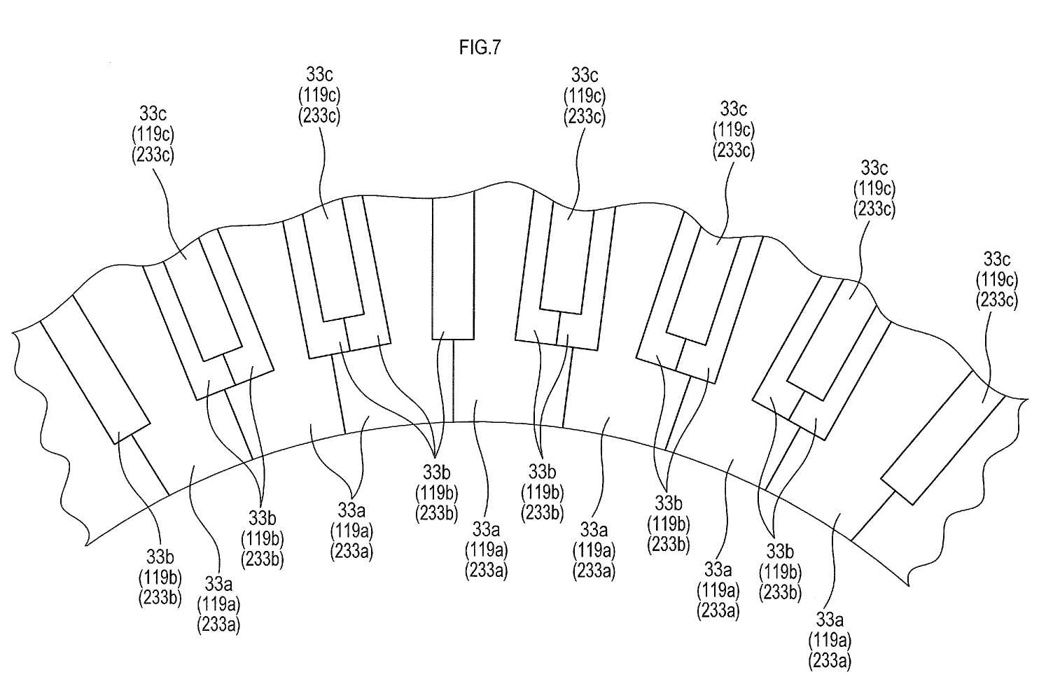

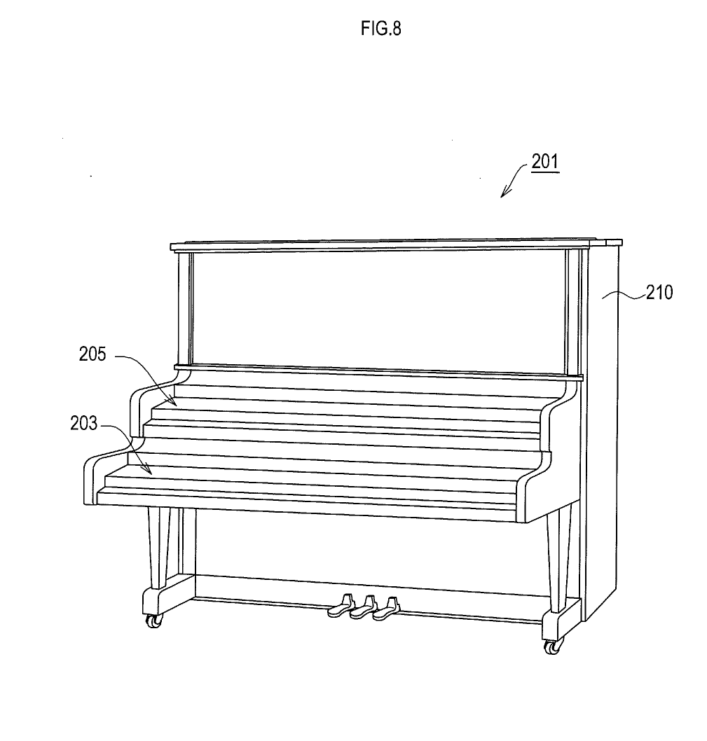

FIG. 4 is an external view showing an electronic keyboard instrument 101. FIG. 5 is a block diagram showing a circuit structure of the electronic keyboard instrument 101. FIG. 6 is a sectional view showing the electronic keyboard instrument 101. It is to be noted that, in FIG. 4, keys 115 of a keyboard device 120 and a keyboard cover panel, provided so as to cover two keyboard devices 120, are partially not shown.

[1. Description of Structure of Electronic Keyboard Instrument 101]

The electronic keyboard instrument 101 according to the present embodiment is provided with, as shown in FIG. 5, the keyboard devices 120, a sound generation control circuit 175, and a sound generation portion 185. Each of the keyboard devices 120 includes a plurality of keys 115 and a key switch 160 that detects key depression. The sound production control circuit 175 generates musical tone signals according to key depression information detected by the key switch 160. The sound generation portion 185 changes the musical tone signals generated in the sound generation control circuit 175 into musical tones.

Moreover, as shown in FIG. 6, one of the two keyboard devices 120 (keyboard device 120a) is disposed in a front portion of the electronic keyboard instrument 101. The other keyboard device 120 (keyboard device 120b) is disposed diagonally behind and above the keyboard device 120a, which is one of the two keyboard devices 120. It is to be noted that, in FIG. 6, a keyboard cover panel, provided so as to cover the two keyboard devices 120, is not shown.

The following describes a structure of the keyboard device 120a.

The keyboard device 120a includes a keyboard chassis 111a, a plurality of keys 115, an action chassis 112, a plurality of hammer mechanisms 115, and key switches 160. The keyboard chassis 111a is disposed on a shelf board 110a. The plurality of keys 115 is pivotably supported by balance pins 113 of the keyboard chassis 111a. The action chassis 112 is disposed on the shelf board 110a in a standing manner. The plurality of hammer mechanisms 155 and the key switches 160 are attached to the action chassis 112.

The keys 115 include, as shown in FIG. 3, first keys 115a, second keys 115b, and third keys 115c. 28 first key pieces 115a, 47 second key pieces 115b, and 20 third key pieces 115c are respectively lined up linearly in the lateral direction, and disposed in the order of the first keys 115a, the second keys 115b, and then the third keys 115c from the front side. It is to be noted that the keys 115 for one octave are shown in FIG. 3.

It is to be noted that the first keys 115a are white, the second keys 115b are blue, and the third keys 115c are black.

Moreover, a step is created between the first keys 115a and the second keys 115b. A step is also created between the second keys 115b and the third keys 115c. Heights (positions) of the respective keys 115 are: the first keys 115a are the lowest of all; the second keys 115b are higher than the first keys 115a; and the third keys 115c are higher than the second keys 115b, in other words, the highest of all.

It is to be noted that the first keys 115a correspond to white keys of a conventional electronic piano, and that the third keys 115c correspond to black keys of a conventional electronic piano.

As shown in FIG. 3, between two first key pieces 115a, having a pitch different by a whole tone, cutouts are respectively formed in mutually facing portions of the first keys 115a, and two second key pieces 115b are disposed in the cutouts. Between two adjacently disposed second key pieces 115b, cutouts are respectively formed in mutually facing portions of the second keys 115b, and one piece of the third keys 115c is disposed in the cutouts. Between two first key pieces 115a, having a pitch different by a half tone, cutouts are respectively formed in mutually facing portions of the first keys 115a, and one piece of the second keys 115b is disposed in the cutouts.

As shown in FIG. 6, the keyboard chassis 111a is secured on the shelf board 110. A plurality of the balance pins 113 is lined up in a standing manner in the lateral direction in a middle portion in the front-to-rear direction of the keyboard chassis 111a.

The action chassis 112 is disposed on the shelf board 110 in a standing manner. The action chassis 112 is provided with a hammer supporting portion 116, a switch attachment portion 117, and a key placement portion 122 in an integrated manner. The hammer supporting portion 116 extends in the lateral direction in the side of the rear portions 114a of the plurality of keys 115 as long as the entire keys 115 extend, and supports the plurality of the hammer mechanisms 155. The switch attachment portion 11 extends in the lateral direction in the side of the rear portions 114a of the plurality of keys 115 to the extent of the entire keys 115, and a plurality of key switches 160 is attached thereon. The key placement portion 112 is disposed below the hammer supporting portion 116. On a bottom surface of a leading end portion of the switch attachment portion 117, a hammer stopper 118, extending in the lateral direction to the extent of the entire hammer mechanisms 155, and formed in a strip-like shape, is disposed. The key placement portion 122 is disposed on a rear end portion of the keyboard chassis 111.

The hammer mechanisms 155 are provided to the respective keys 115, and rotatably supported by the hammer supporting portion 116 of the action chassis 112.

The following describes a structure of the keyboard device 120b.

The keyboard device 120b is disposed, as described above, obliquely behind and above the keyboard device 120a. More particularly, the keyboard device 120b includes a keyboard chassis 111b, the plurality of keys 115, the action chassis 112, the plurality of hammer mechanisms 155, and the key switches 160. The keyboard chassis 111b is disposed on the middle shelf board 110b. The plurality of keys 115 is pivotably supported by the balance pins 113 of the keyboard chassis 111b. The action chassis 112 is disposed on the middle shelf board 110b in a standing manner. The plurality of hammer mechanisms 155 and the key switches 160 are attached to the action chassis 112.

It is to be noted that the keys 115, the action chassis 112, the hammer mechanisms 155, and the key switches 160 of the keyboard device 120b are constructed similarly to the keys 155, the action chassis 112, the hammer mechanisms 155 and the key switches 160 of the keyboard device 120a, and that detailed explanation thereof is not repeated here.

Moreover, a highest tone produced by one of the keys 115 of the keyboard device 120a and a lowest tone produced by one of the keys 115 of the keyboard device 120b are set so as to be two consecutive tones having a quarter-tone difference therebetween.

As shown in FIG. 5, the above-described sound generation control circuit 175 includes a key scan circuit 176, a CPU 177, a ROM 178, a RAM 179, a waveform memory 181, and a sound source LSI 182. Among these components, the key scan circuit 176 detects a depression state of the keys 115 based on ON/OFF signals from first contact points and second contact points of the key switches 160. The CPU 177 controls an operation of the electronic keyboard instrument 101. Particularly, the CPU 177 determines whether the keys 155 are pressed based on the detection signals of the key switches 160, calculates key depression speed, controls the sound source LSI 182, and so on. The sound source LSI 182 generates musical tone signals corresponding to the keys 115 that are pressed. The ROM 178 stores control programs and the like that are executed in the CPU 177. The RAM 179 temporarily stores data used for controlling the sound generation control circuit 175. The waveform memory 181 stores waveform data for generating musical tone signals.

Moreover, in the sound generation control circuit 175, the pitch between adjacently disposed first key 115a and second key 115b, and the pitch between adjacently disposed second key 115b and third key 115c are set to be quarter tones.

The sound generation portion 185 includes an amplifier 186 and a speaker 187. The amplifier 186 amplifies the musical tone signals generated in the control circuit 175. The speaker 187 outputs the amplified musical tone signals as musical tones.

With the electronic keyboard instrument 101 constructed as above, when the front side of the key 115 is pressed, the key 115 is pivoted about the balance pin 113 as a supporting point, and the rear end portion 114a of the key 115 pushes up the hammer mechanism 155 so as to press the key switch 160. Consequently, the sound generation control circuit 175 generates musical tone signals based on key depression information detected in the key switch 160. Moreover, the sound generation portion 185 converts the musical tone signals, generated in the sound generation control circuit 175, into musical tones, and outputs the musical tones. On the other hand, when operation on the key 115 is stopped, the rear end side of the key 115 descends and returns to an original position, and the output of musical notes from the sound generation portion 185 is also stopped.

It is to be noted that other structures of the electronic keyboard instrument 101 are based on publically known skills, and therefore detailed explanation thereof is not repeated here.

[2. Effect of Second Embodiment]

As described above, in the electronic keyboard instrument 101 according to the present embodiment, the pitch between adjacently disposed first key 115a and second key 115b, and the pitch between adjacently disposed second key 115b and third key 115c are respectively set to be quarter tones. Therefore, the electronic keyboard instrument 101 can produce sound on a quarter-tone basis. Moreover, the keyboard devices 120 are disposed on a plurality of steps (on two steps in the present embodiment) in the up-and-down direction. Therefore, even though the number of keys 115 is increased so that the electronic keyboard instrument 101 can produce sound on a quarter-tone basis, and the range of the sound that the electronic keyboard instrument 101 can produce is widened, all of the keys 115 are disposed within a range sufficiently reachable by the hands of a player who is seated in front of the electronic keyboard instrument 101 and performs. Furthermore, even though the number of keys 115 is increased, the size of the keys 115 does not have to be made smaller. Therefore, fingering during performance is not easily disturbed.

As a result, while ease in performing is ensured, expressiveness as a musical instrument can be further improved.

[3. Another Embodiment]

The above has described an embodiment according to the present invention. However, the present invention is not limited to the above-described embodiment, but may be carried out in various ways as explained below.

(1) As shown in FIG. 7, 28 first key pieces 119a, 47 second key pieces 119b, and 20 third key pieces 119c may be lined up in a fan-shape manner. Moreover, the disposition may be in the order of the first keys 119a, the second keys 119b, and the third keys 119c from the front side. In this case, a step may be created between the first keys 119a and the second keys 119b, and also between the second keys 119b and the third keys 119c. The heights (positions) of the respective keys 119 may be: the first keys 119a are the lowest of all; the second keys 119b are higher than the first keys 119a; and the third keys 119c are higher than the height of the second keys 119b, in other words, the highest of all. Between the two adjacently disposed first key pieces 119a having a pitch different by a whole tone, cutouts are respectively formed in mutually facing portions of the first keys 119a, and two second key pieces 119b may be disposed in the cutouts. Between two adjacently disposed second key pieces 119b, cutouts are respectively formed in mutually facing portions of the second keys 119b, and one piece of the third keys 119c may be disposed in the cutouts. Between two first key pieces 119a, having a pitch different by a half tone, cutouts are respectively formed in mutually facing portions of the first keys 119a, and one piece of the second keys 119b may be disposed in the cutouts.

### Third Embodiment

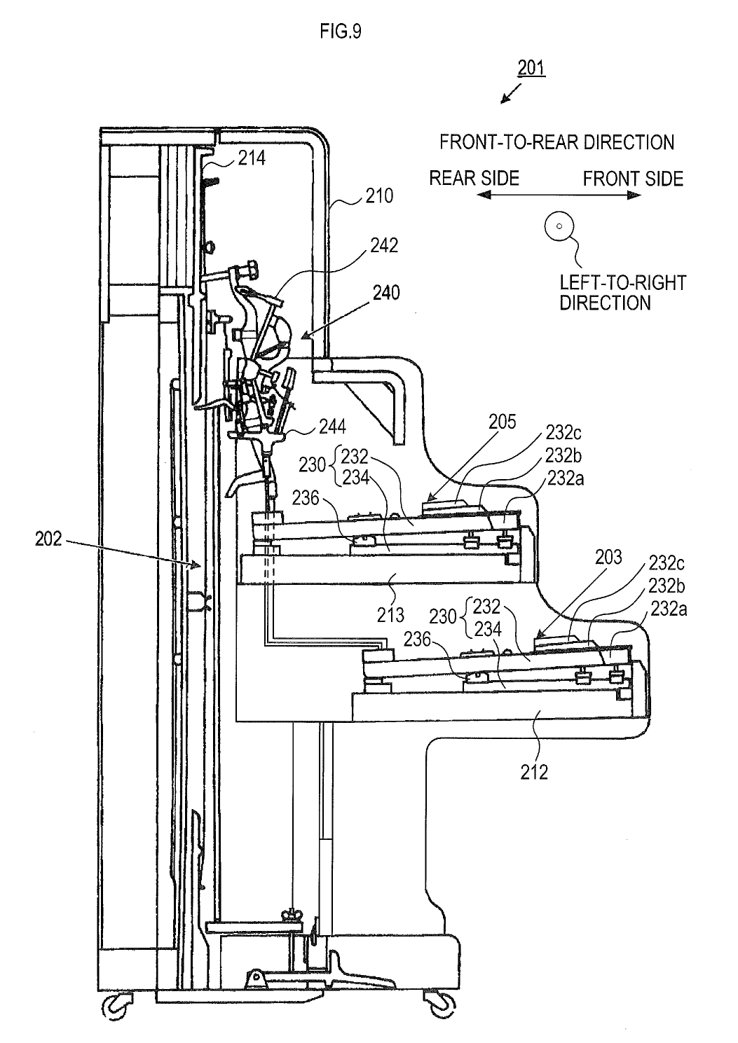

FIG. 8 is an external view showing an upright piano 201. FIG. 9 is a sectional view showing a front portion of the upright piano 201. FIG. 3 is a detail diagram showing a key portion 230. It is to be noted that, in FIG. 8, the key portions 230 of action devices 203, 205, and a keyboard cover panel that covers the action devices 203, 205 are not shown.

[1. Description of Structure of Upright Piano 201]

The upright piano 201 according to the present embodiment includes, as shown in FIG. 8, two action devices 203, 205, provided so as to strike strings by depression of keys, and a transmission portion 240.

The action device 203 is disposed in the front portion of the upright piano 201, whereas the action device 205 is disposed diagonally behind and above the action device 203.

The following describes a structure of the action device 203.

As shown in FIG. 9, the action device 203 is disposed on a shelf board 212 of a piano main body 210, and provided with a key portion 230.

The key portion 230 of the action device 203 is constituted with keys 232 and a key bed 234, and disposed on the shelf board 212. The key portion 230 is provided with 95 key pieces 232 for four octaves. The respective keys 232 are disposed in parallel on the key bed 234. The key bed 234 is a long plate member extending in the arrangement direction of the keys 232 (lateral direction). In the middle of a width direction of the key bed 234, a middle key bed 236, extending in the arrangement direction of the keys 232, is disposed. The keys 232 are disposed on the key bed 234 so as to rotate around the middle key bed 236 as a supporting point.

The keys 232 include first keys 232a, second keys 232b, and third keys 232c. 28 first key pieces 232a, 47 second key pieces 232b, and 20 third key pieces 232c are respectively lined up linearly in a lateral direction, and disposed, from the front, in the order of the first keys 232a, the second keys 232b, and then the third keys 232c. In FIG. 3, the keys 232 for one octave are shown.

It is to be noted that the first keys 232a are white, the second keys 232b are blue, and the third keys 232c are black.

Moreover, a step is created between the first keys 232a and the second keys 232b. A step is also created between the second keys 232b and the third keys 232c. Heights (positions) of the respective keys 232 are: the first keys 232a are the lowest; the second keys 232b are higher than the first keys 232a; and the third keys 232c are higher than the second keys 232b, in other words, the highest of all.

It is to be noted that the first keys 232a correspond to white keys of a conventional acoustic piano, and that the third keys 232c correspond to black keys of a conventional acoustic piano.

As shown in FIG. 3, in the key portion 230, between two first key pieces 232a, having a pitch different by a whole tone, cutouts are respectively formed in mutually facing portions of the first keys 232a, and two second key pieces 232b are disposed in the cutouts. Between two adjacently disposed second key pieces 232b, cutouts are respectively formed in mutually facing portions of the second keys 232b, and one piece of the third keys 232c is disposed in the cutouts. Between two first key pieces 232, having a pitch different by a half tone, cutouts are respectively formed in mutually facing portions of the first keys 232a, and one piece of the second keys 232b is disposed in the cutouts.

The action device 205 is disposed, as described above, diagonally behind and above the action device 203. More specifically, the action device 205 is disposed on a middle shelf board 213 of the piano main body 210 disposed above the action device 203. The action device 205 is provided with the key portion 230. Since the key portion 230 of the action device 205 is constructed similarly to the key portion 230 of the action device 203, detailed explanation thereof is not repeated here.

The highest tone produced in the key portion 230 of the action device 203 and the lowest tone produced in the key portion 230 of the action device 205 are set so as to be two consecutive tones having a quarter-tone difference therebetween.

The transmission portion 240 is constituted with hammers 242 and actions 244. 190 hammer pieces 242 and the actions 244 are provided. The hammers 242 and the actions 244 are respectively lined up in the lateral direction inside the piano main body 210 so as to be provided correspondingly to the keys 232, constituting the key portion 230 of the action device 203, and to the keys 232, constituting the key portion 230 of the action device 205. Each of the actions 244 is disposed in a position between the hammer 242 and the key 232, and in a position wherein the action 244 can rotate the hammer 242, when the key 232 is pressed. It is to be noted that the actions 244 have a structure generally used for actions provided in the upright piano 1, and therefore detailed description thereof is not given here.

Strings 202 are provided correspondingly to the respective keys 232. The strings 202 for respective pitches are secured at the end portions thereof with tuning pins (not shown) and frame pins (not shown) with respect to a frame 214 disposed behind the key portion 230 so as to be approximately vertically stretched to a predetermined tension. In the upright piano 201 according to the present embodiment, each of the strings 202 is disposed in the taut manner such that a pitch between adjacently disposed first key 232a and second key 232b, and the pitch between adjacently disposed second key 232b and third key 232c respectively become quarter tones.

In each of the action device 203 and the action device 205, the rear side of the keys 232 is usually inclined. When the front side of the key 232 is pressed, the key 232 is pivoted about the middle key bed 236 as a supporting point, and rotates the hammer 42 via the action 244 so as to strike the string 202. When the operation on the key 232 is stopped, the key 232 is returned to an original position due to the weight of the hammer 242 and the action 244.

Since other structure of the upright piano 201 is based on the conventionally known technique, detailed explanation thereof is not repeated here.

[2. Effect of Third Embodiment]

As described above, in the upright piano 101 according to the present embodiment, the key portion 230 of the action device 203 and the key portion 230 of the action device 205 are respectively provided with 95 key pieces 232 for four octaves. The keys 232 include the first keys 232a, second keys 232b and the third keys 232c. The key portions 230 are respectively provided with 28 first key pieces 232a, 47 second key pieces 232b, and 20 third key pieces 232c. The first keys 232a, the second keys 232b, and the third keys 232c are respectively lined up in a linear manner in the lateral direction, and arranged in the order of the first keys 232a, the second keys 232b, and the third keys 232c from the front side. A step is created between the first keys 232a and the second keys 232b. A step is also created between the second keys 232b and the third keys 232c. The heights (positions) of the respective keys 232 are: the first keys 232a are the lowest; the second keys 232b are higher than the first keys 232a; and the third keys 232c are higher than the second keys 232b, in other words, the highest of all. Furthermore, each of the strings 202 is pulled and disposed such that the pitch between adjacently disposed first key 232a and second key 232b, and the pitch between adjacently disposed second key 232b and the third key 232c respectively become quarter tones. This enables the upright piano 201 to produce sound on a quarter-tone basis. Moreover, since the action devices 203, 205 are disposed on a plurality of steps (two steps in the present embodiment) in the up-and-down direction, even though the number of keys 232 is increased so that the upright piano 201 can produce sound on a quarter-tone basis and the range of the sound that the upright piano 201 can produce is widened, all of the keys 232 are disposed within a range sufficiently reachable by the hands of a player who is seated in front of the upright piano 201 and performs. Additionally, even though the number of keys 232 is increased, the size of the respective keys 232 does not have to be made smaller. Therefore, fingering during performance is not easily disturbed.

As a result, while ease in performing is ensured, expressiveness as a musical instrument can be further improved.

[3. Another Embodiment]

The above has described an embodiment according to the present invention. However, the present invention is not limited to the above-described embodiment, but may be carried out in various ways as explained below.

(1) As shown in FIG. 7, 28 first key pieces 233a, 47 second key pieces 233b, and 20 third key pieces 233c may be lined up in a fan-shape manner. Moreover, the disposition may be in the order of the first keys 233a, the second keys 233b, and the third keys 233c from the front side. In this case, a step may be created between the first keys 233a and the second keys 233b, and also between the second keys 233b and the third keys 233c. The heights (positions) of the respective keys 233 may be: the first keys 233a are the lowest of all; the second keys 233b are higher than the first keys 233a; and the third keys 233c are higher than the second keys 233b, in other words, the highest of all. Between the two first key pieces 233a having a pitch different by a whole tone, cutouts are respectively formed in mutually facing portions of the first keys 233a, and two second key pieces 233b may be disposed in the cutouts. Between two adjacently disposed second key pieces 233b, cutouts are respectively formed in mutually facing portions of the second keys 233b, and one piece of the third key 233c may be disposed in the cutouts. Between two first key pieces 233a, having a pitch different by a half tone, cutouts are respectively formed in mutually facing portions of the first keys 233a, and one piece of the second keys 233b may be disposed in the cutouts.

### Fourth Embodiment

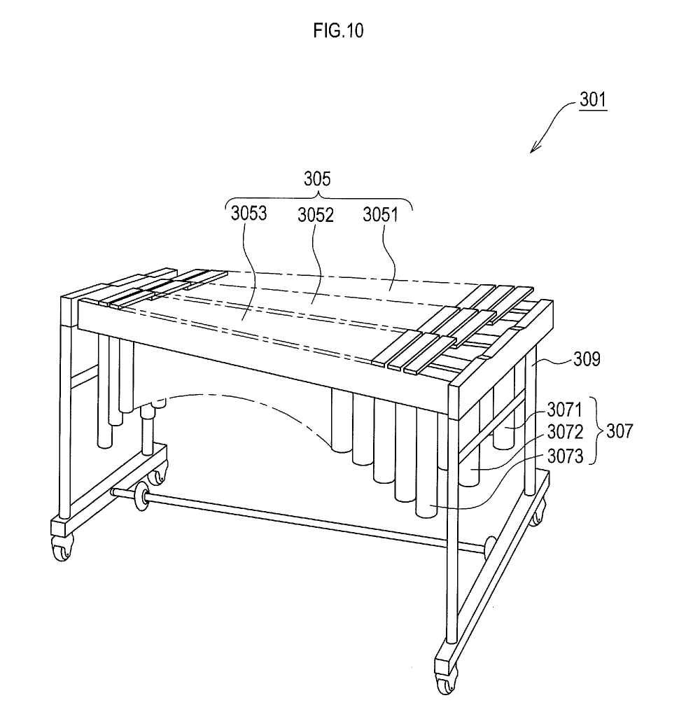

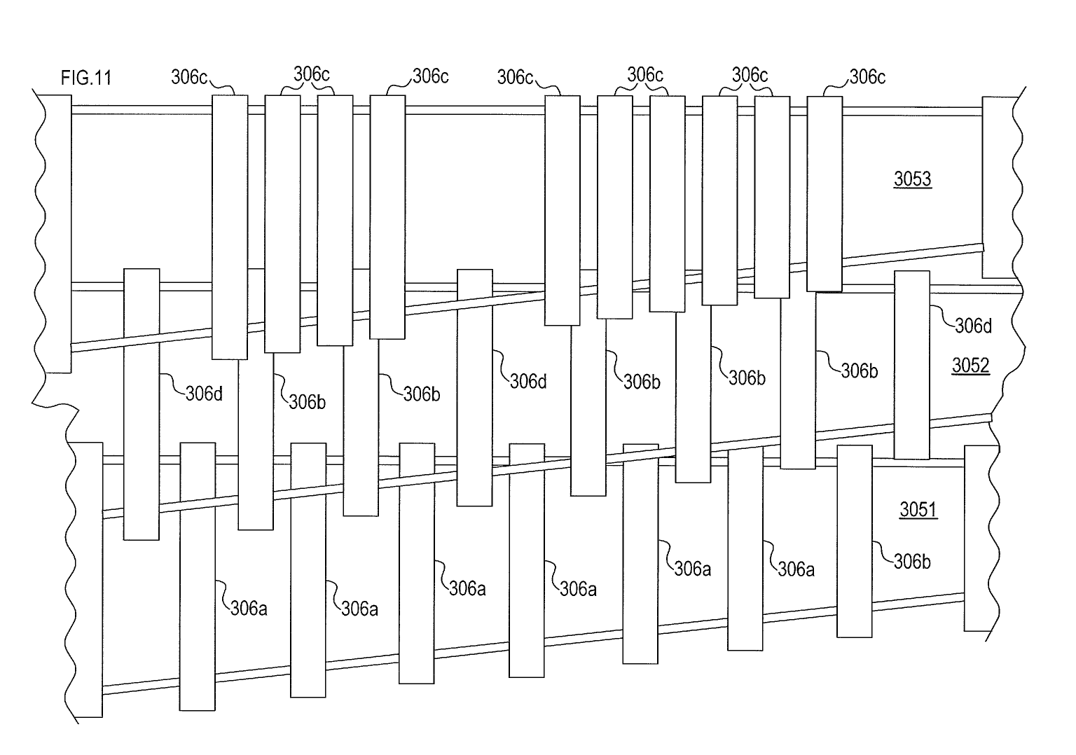

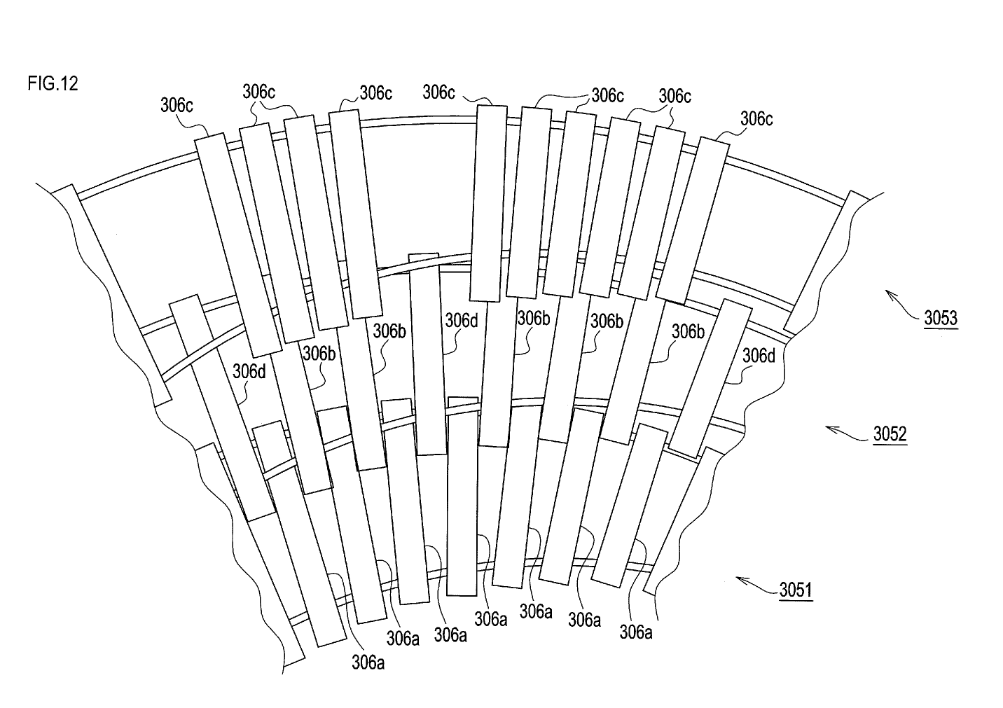

FIG. 10 is an external view showing a marimba 301. FIG. 11 is a detail view showing bars 305 of the marimba 301.

[1. Description for Structure of Marimba 301]

As show in FIG. 10, the marimba 301 according to the present embodiment includes bars 305, pipes 307, and an instrument stand 309. The bars 305 and the pipes 307 are respectively constituted with a plurality of bars and a plurality of pipes, and attached to the instrument stand 309.

The bars 305 are constituted with a plurality of primary-tone bars 3051 disposed in a front row, a plurality of accidental-tone bars 3052 disposed in a middle row, and a plurality of accidental-tone bars 3053 disposed in a rear row. The bars 305 are disposed on three steps in the front-to-rear direction on an upper surface of the instrument stand 309. The primary-tone bars 3051, the accidental-tone bars 3052 and the accidental-tone bars 3053 are respectively provided with two through holes penetrating the bars in the width direction at two points which are nodes of primary (fundamental) vibration. The primary-tone bars 3051, the accidental-tone bars 3052, and the accidental-tone bars 3053 are supported by strings that are not shown in the drawing, but respectively penetrate the through holes.

The primary-tone bars 3051 in the front row include one type of bars (first bars 306a) linearly lined up in the lateral direction. The accidental-tone bars 3052 in the middle row include two types of bars (second bars 306b and fourth bars 306d) respectively lined up linearly in the lateral direction. The accidental-note bars 3053 in the rear row include one type of bars (third bars 306c) linearly lined up in the lateral direction. It is to be noted that, in FIG. 11, the first bars 306a, the second bars 306b, the third bars 306c, and the fourth bars 306d for one octave are shown.

As shown in FIG. 11, between two first bar pieces 306a having a pitch different by a whole tone, the second bar 306b is disposed. Between the first bar 306a and the second bar 306b, and between the second bar 306b and the first bar 306a respectively having pitches different by half tones, the third bars 306c are respectively disposed. Between two first bar pieces 306a having a pitch different by a half tone, the fourth bar 306d is disposed.

The pitches between adjacently disposed first bar 306a and second bar 306b, between adjacently disposed second bar 306b and third bar 306c, between adjacently disposed first bar 306a and third bar 306c, and between adjacently disposed first bar 306a and fourth bar 306d are respectively quarter tones.

The pipes 307 are constituted with primary-tone pipes 3071 disposed in the front row, accidental-tone pipes 3072 in the middle row, and accidental-tone pipes 3073 in the rear row. The primary-tone pipes 3071, the accidental-tone pipes 3072, and the accidental-tone pipes 3073 of the pipes 307 are provided so as to increase volume of sound by resonating respectively with the sound of the primary-tone bars 3051, the accidental-tone bars 3052, and the accidental-tone bars 3053, and by being vibrated. The primary-tone pipes 3071, the accidental-tone pipes 3072, and the accidental-tone pipes 3073 are suspended under corresponding bars, that is, the primary-tone bars 3051, the accidental-tone bars 3052, and the accidental-tone bars 3053 respectively. The primary-tone pipes 3071, the accidental-tone pipes 3072, and the accidental-tone pipes 3073 are made of pipes having open upper ends and closed lower ends, and have primary frequencies that are approximately similar to the primary vibrations of corresponding bars: the primary-tone bars 3051, the accidental-tone bars 3052, and the accidental-tone bars 3053.

[2. Effect of Fourth Embodiment]

In the marimba 301 according to the present embodiment, between two first bar pieces 306a having a pitch different by a whole tone, the second bar 306b is disposed; between the first bar 306a and the second bar 306b, and between the second bar 306b and the first bar 306a respectively having pitches different by half tones, the third bars 306c are respectively disposed; between two first bar pieces 306a having a pitch different by a half tone, the fourth bar 306d is disposed. The pitches between adjacently disposed first bar 306a and second bar 306b, between adjacently disposed second bar 306b and third bar 306c, between adjacently disposed first bar 306a and third bar 306c, and between adjacently disposed first bar 306a and fourth bar 306d are respectively quarter tones.

This enables the marimba 301 to produce sound on a quarter-tone basis. Moreover, the bars 305 are disposed on three steps in the front-to-rear direction, that is, the primary-tone bars 3051 are disposed in the front row, the accidental-tone bars 3052 are disposed in the middle row, and the accidental-tone bars 3053 are disposed in the rear row. Therefore, even though the number of bars 305 is increased so that the marimba 301 can produce sound on a quarter-tone basis, and the range of the sound that the marimba 301 can produce is widened, all of the bars 305 are disposed within a range sufficiently reachable by the hands of a player who is seated in front of the marimba 301 and performs. Additionally, even though the number of bars 305 is increased, the size of the respective bars 305 does not have to be made smaller. Therefore, fingering during performance is not easily disturbed.

As a result, while ease in performing is ensured, expressiveness as a musical instrument can be further improved.

[3. Other Embodiments]

The above has described an embodiment according to the present invention. However, the present invention is not limited to the above-described embodiment, but may be carried out in various ways as explained below.

(1) As shown in FIG. 12, the primary-tone bars 3051 may be constructed such that the first bars 306a are lined up in a fan-shape manner. The accidental-tone bars 3052 may be constructed such that the second bars 306b and the fourth bars 306d are lined up in a fan-shape manner. The accidental-tone bars 3053 may be constructed such that the third bars 306c are lined up in a fan-shape manner. In this case, the disposition bars may be similar to the above-described embodiment, wherein between two first bar pieces 306a having a pitch different by a whole tone, the second bar 306b may be disposed; between the first bar 306a and the second bar 306b, and between the second bar 306b and the first bar 306a respectively having pitches different by half tones, the third bars 306c may be respectively disposed; between two first bar pieces 306a having a pitch different by a halt tone, the fourth bar 306d may be disposed. The pitches between adjacently disposed first bar 306a and second bar 306b, between adjacently disposed second bar 306b and third bar 306c, between adjacently disposed first bar 306a and third bar 306c, and between adjacently disposed first bar 306a and fourth bar 306d may be respectively quarter tones.

(2) The present invention may be applied to other keyboard percussion instruments, such as xylophone, vibraphone, and so on.

1. A keyboard instrument in which a plurality of keys is lined up in order and each supported so as to be pivotable around a supporting point, when the keys are pressed, rear end portions of the keys rotate corresponding hammers and leading end portions of the hammers, which are being rotated, strike strings so as to produce sound,
the keyboard instrument having the strings pulled in a taut manner to a predetermined tension by both end portions thereof being secured with tuning pins and frame pins,
wherein the keys comprise first keys, second keys, and third keys,
wherein the first keys, the second keys, and the third keys constitute key portions, in which the first keys, the second keys, and the third keys are respectively lined up according to types of the keys in a lateral direction and disposed in order of the first keys, the second keys, and the third keys from a front side, the key portions being disposed on a plurality of steps in an up-and-down direction,
wherein each of the key portions is constituted such that between two first key pieces, having a pitch different by a whole tone, cutouts are formed in mutually facing portions of the respective first keys, and two second key pieces are disposed therein; between two second key pieces adjacently disposed, cutouts are formed in mutually facing portions of the respective second keys, and one piece of the third keys is disposed therein; and between two first key pieces, having a pitch different by a half tone, cutouts are formed in mutually facing portions of the respective first keys, and one piece of the second keys is disposed therein,
wherein the hammers and the strings are provided correspondingly to the respective keys, and
wherein the strings are respectively pulled in the taut manner such that the pitch between the first keys and the second keys adjacently disposed, and the pitch between the second keys and the third keys adjacently disposed respectively become quarter tones.

2. A keyboard instrument in which a plurality of keys is lined up in order and each supported so as to be pivotable around a supporting point, and when the keys are pressed, rear end portions of the keys, which are being rotated, are detected so as to produce sound,
the keys comprising first keys, second keys, and third keys,
wherein the first keys, the second keys, and the third keys constitute key portions, in which the first keys, the second keys, and the third keys are respectively lined up according to types of the keys in a lateral direction and disposed in order of the first keys, the second keys, and the third keys from a front side, the key portions being disposed on a plurality of steps in an up-and-down direction,
wherein each of the key portions is constituted such that between two first key pieces, having a pitch different by a whole tone, cutouts are formed in mutually facing portions of the respective first keys, and two second key pieces are disposed therein; between two second key pieces adjacently disposed, cutouts are formed in mutually facing portions of the respective second keys, and one piece of the third keys is disposed therein; and between two first key pieces, having a pitch different by a half tone, cutouts are formed in mutually facing portions of the respective first keys, and one piece of the second keys is disposed therein, and
wherein the pitch between the first keys and the second keys adjacently disposed, and the pitch between the second keys and the third keys adjacently disposed are set so as to respectively become quarter tones.

3. A keyboard instrument in which sound is produced by a plurality of bars, lined up in order, being struck, and volume of the sound is increased by pipes, suspended under the bars, resonating with the sound and being vibrated,
the keyboard instrument having the bars provided with a plurality of primary-tone bars, disposed in a front-row side, and a plurality of accidental-tone bars, disposed in a rear-row side, the bars being disposed on a plurality of steps in a front-to-rear direction,
wherein the primary-tone bars are constituted with first bars lined up in a lateral direction,
wherein the accidental-tone bars are constituted with second bars, third bars, and fourth bars respectively lined up in the lateral direction,
wherein between two first bar pieces, having a pitch different by a whole tone, the second bar is disposed; between the first bar and the second bar, having a pitch different by a half tone, the third bar is disposed; and between two first bar pieces having a pitch different by a half tone, the fourth bar is disposed,
wherein the pitch between the first bars and the second bars adjacently disposed, the pitch between the second bars and the third bars adjacently disposed, the pitch between the first bars and the third bars adjacently disposed, and the pitch between the first bars and the fourth bars adjacently disposed respectively become quarter tones.
